(19) United States
(12) Patent Application Publication
(10) Pub. No.: US 2026/0025396 A1
(43) Pub. Date: Jan. 22, 2026

(54) SYSTEMS AND METHODS FOR DETECTING INSIDER THREATS

(71) Applicant: Royal Bank of Canada, Toronto (CA)

(72) Inventors: Fatima Hussain, Oakville (CA); Moussa Noun, Bedford (CA)

(21) Appl. No.: 19/272,434

(22) Filed: Jul. 17, 2025

Related U.S. Application Data
(60) Provisional application No. 63/673,971, filed on Jul. 22, 2024.

(51) Int. Cl. H04L 9/40

(52) U.S. Cl. CPC H04L 63/1425; H04L 63/1433

(57) ABSTRACT

Methods, systems, and techniques for detecting insider threat incidents are disclosed, comprising: receiving event data from a computing device of an event to be analyzed for an insider threat; accessing a vector database storing vector representations of known insider threat incidents; and determining a risk that the event is an insider threat incident based on the event data and the vector representations of the known insider threat incidents.

### CROSS=REFERENCE TO RELATED APPLICATIONS

This application claims priority to U.S. Provisional Patent Application No. 63/673,971, filed Jul. 22, 2024, the entire contents of which is incorporated herein by reference for all purposes.

### TECHNICAL FIELD

The present disclosure is directed at methods, systems, and techniques for detecting insider threats.

### BACKGROUND

Existing systems and methodologies for detecting insider threats are either rule-based or focused on supervised machine learning approaches, where models are trained on previous incidents and new events are classified into malicious/non-malicious groups after running through the model. However, insider threats are constantly evolving and conventional supervised machine learning techniques do not suffice for accurate prediction/classification.

Accordingly, methods, systems, and techniques for detecting insider threats remain desirable.

### SUMMARY

According to a first aspect, there is provided a method of detecting insider threat incidents, comprising: receiving event data from a computing device of an event to be analyzed for an insider threat; accessing a vector database storing vector representations of known insider threat incidents; and determining a risk that the event is an insider threat incident based on the event data and the vector representations of the known insider threat incidents.

In some aspects, the method further comprises generating the vector database storing the vector representations of known insider threat incidents by obtaining the known insider threat incidents and generating vector representations of the known insider threat incidents.

In some aspects, the known insider threat incidents are obtained in near-real-time.

In some aspects, the method further comprises generating a vector representation of the event data, wherein determining the risk is based on a distance between the vector representation of the event data and the vector representations of the known insider threat incidents.

In some aspects, the risk is determined using a large language model that has been contextually-trained on known insider threat incidents.

In some aspects, the large language model performs retrieval-augmented generation using the vector database to determine the risk.

In some aspects, the method further comprises maintaining statistics of a number of times each record in the vector database has been accessed, and fine-tuning the large language model based on the statistics.

In some aspects, the method further comprises training the large language model based on a subset of the vector representations stored in the vector database.

In some aspects, the method further comprises classifying the risk that the event is an insider threat incident and generating an output indicative of a classification result.

In some aspects, the insider threat incident pertains to data loss.

In some aspects, the event data comprises email data.

In accordance with another aspect of the present disclosure, a system for detecting insider threat incidents is disclosed, comprising: a vector database storing vector representations of known insider threat incidents; a processor; and a non-transitory computer-readable medium having computer-executable instructions stored thereon which, when executed by the processor, configure the system to perform the method of detecting insider threat incidents of any one of the above aspects.

In accordance with another aspect of the present disclosure, a non-transitory computer-readable medium is disclosed having computer-executable instructions stored thereon which, when executed by a processor, configure the processor to perform the method of detecting insider threat incidents of any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for detecting insider threat incidents.

FIG. 2 is a block diagram of a server comprising part of the system depicted in FIG. 1.

FIG. 3 shows a method of detecting insider threat incidents.

FIG. 4 depicts an architecture of a system for detecting insider threat incidents.

FIG. 5 depicts an exemplary flow diagram for detecting insider threats.

FIG. 6 depicts an exemplary flow diagram for detecting insider threats using a large language model.

FIG. 7 shows a representation of how the vector database is used by a large language model.

FIG. 8 shows a further method of detecting insider threat incidents.

### DETAILED DESCRIPTION

Existing insider threat controls based on user behavioural analytics have various limitations and drawbacks. Tools may be used to analyze email content and attachments to determine if an outbound email is risky or non-risky (e.g. based on whether it is determined to contain sensitive or confidential information). However, most existing insider threat controls are based on metadata analysis and anomaly detection, and typically only provide limited information such as anomaly scores of specific events with some probability. Therefore, contextualization of detected events and manual review is required for further analysis of events. Large Language Models (LLMs) are being contemplated for cybersecurity applications, however there is a critical gap in their implementation, namely that the rapid change of Tactics, Techniques and Procedures (TTPs) employed by threat actors can quickly outpace the ability to fine-tune LLM based controls.

Methods, systems, and techniques are disclosed herein for detecting insider threat incidents that utilize a vector database storing vector representations of real-world incidents that are continuously collected and aggregated, including in real-time or near-real-time. Vector representations are generated and stored for known insider threat incidents, including near-real-time incidents, to provide a complete incident knowledge database with actual artifacts of insider threat incidents, in addition to the metadata, thus capturing the latest TTPs employed by threat actors. The known insider threat incidents may be obtained directly from the audience the vector database is to be used for (e.g. an organization).

With the vector database, various insider threat detection functionality may be used to determine a risk that an event is an insider threat incident. The accuracy and computational efficiency of the detection can be improved as a result of the vector database. In one example, a distance between a vector representation of event data and the vector representations of the known insider threat incidents can be determined and used to classify a risk of an event being an insider threat. Additionally or alternatively, a contextually-trained large language model (LLM) may be used to determine whether the event poses a risk of being an insider threat incident. A subset of the vector representations stored in the vector database may be used for contextually-training the large language model to detect insider threat incidents. The training data may be specific to an organization for improved accuracy and thus avoid the need for sophisticated prompt engineering. The vector database can also be used for fine-tuning the large language model and simultaneously supporting real-time inferencing accuracy by providing a continuously updated set of real-world cyber incidents with the latest Tactics, Techniques and Procedures, i.e. beyond what the LLM was initially trained on.

For example, the vector representations of known incidents may be leveraged by the trained LLM at inference (e.g. using Retrieval-Augmented Generation (RAG) techniques) as well as for fine-tuning (e.g. using Retrieval-Augmented Fine-Tuning (RAFT) techniques). By providing a continuously-updated vector database of near-real-time insider threat data as incident data and combining an LLM-based control with RAG and RAFT techniques provides the LLM with an up-to-date source of incident data to inference against as well as simultaneously provides a repository to use for rapidly fine-tuning the LLM. Accordingly, adaptive AI model management may be performed, focusing on controlled fine-tuning and the integration of RAG to preserve the LLM's core functionalities while incorporating real-time information updates. Therefore, a more accurate, rapidly adapting, insider threat control can be implemented that applies the best available fine-tuned LLM with the latest incident data to quickly adapt to the current environment, without requiring retraining of the entire LLM, which is time-consuming and computationally expensive.

Use of an LLM can advantageously be specifically tuned for detecting insider threat incidents and can perform content analysis as opposed to just metadata analysis. Events can be classified into incident/non-incident groups, in contrast to probability. Additional context may also be provided to explain the model's decisions, avoiding the need for manual review/analysis, which results in increased efficiency, accuracy, and automation for insider threat mitigation, as well as reduction in the cost of investigation and remediation.

Accordingly, embodiments of the methods, systems, and techniques for detecting insider threat incidents disclosed herein can advantageously provide one or more of the following benefits:
Development of a vector database of previous insider threat incidents that are continuously collected and aggregated, including in real-time or near-real-time;
Development of a contextually-trained LLM to detect insider threat incidents along with the justification or reasoning of a specific event being an incident;
Adaptive AI model management, focusing on controlled fine-tuning and the integration of Retrieval-Augmented Generation (RAG) to preserve the model's core functionalities while incorporating real-time information updates;
Continuous learning and automated update of the prompts for LLM with the inclusion of new incidents in the vector database;
Specialized result-focused “chain of thoughts prompts” and “Retrieved knowledge prompts” engineering in order to generate specially formatted output.

In at least some embodiments herein, methods, systems, and techniques for detecting insider threat incidents comprise: receiving event data from a computing device of an event to be analyzed for an insider threat; accessing a vector database storing vector representations of known insider threat incidents; and determining a risk that the event is an insider threat incident based on the event data and the vector representations of the known insider threat incidents.

While the present disclosure in particular contemplates the methods, systems, and techniques for detecting insider threat incidents, it will be appreciated that the methods, systems, and techniques disclosed herein may be utilized for detecting other types of cybersecurity incidents as well, with the vector database storing vector representations of such known cybersecurity incidents for use in determining a risk that an event is such a cybersecurity incident.

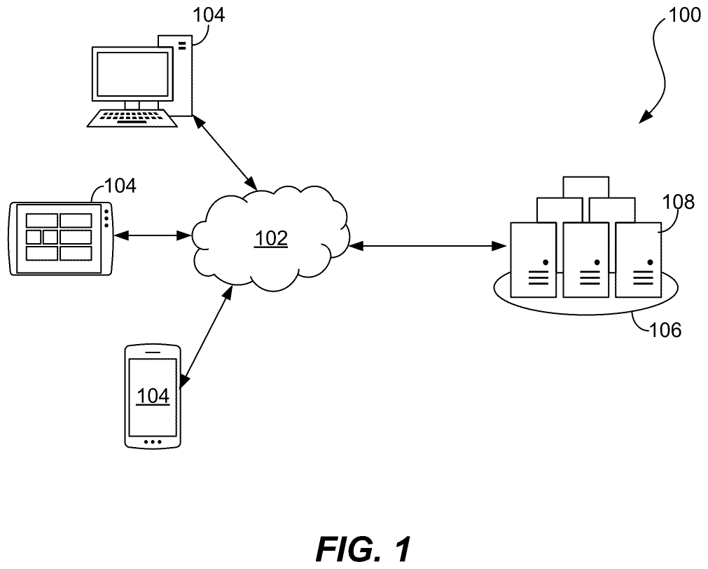

Referring now to FIG. 1, there is shown a computer network 100 that comprises an example embodiment of a system for detecting insider threat incidents. More particularly, the computer network 100 comprises a wide area network 102 such as the Internet to which various user devices 104, and data center 106 are communicatively coupled. The data center 106 comprises a number of servers 108 networked together to collectively perform various computing functions. For example, in an organization, the data center 106 may host online services provided by that organization, and may store sensitive information, such as confidential information belonging to the organization, customer/employee data, etc. In the context of a financial institution such as a bank, for example, the data center hosts online banking services that permit users to perform various computer-implemented banking services, and also stores sensitive customer information, employee information, confidential management documents, etc.

It will be appreciated that insider threats such as data loss incidents (e.g. where an employee from within an organization transmits sensitive data outside of the organization) are a major concern to organizations. In accordance with the present disclosure, methods, systems, and techniques for detecting insider threat incidents are disclosed that utilize a vector database with the latest insider threat incident data to perform automatic insider threat incident detection with increased efficiency, accuracy, and automation. The methods, systems, and techniques disclosed herein can be used to detect and mitigate insider threats to protect organizations from potential insider threats and the associated consequences including regulatory, financial, legal, and reputational damage. In the event that an insider threat incident is detected, the methods, systems, and techniques disclosed herein can also reduce the time, resources, and cost of investigation and remediation in security breaches and incident situation. In particular aspects of the present disclosure, the methods, systems, and techniques may be used for detecting data loss incidents, such as e-mails containing sensitive and/or confidential information that are attempting to be sent externally from the organization. However, it will be appreciated that the methods, systems, and techniques disclosed herein can be used for detecting a wide range of insider threat incidents and other cybersecurity incidents, and can be applied to various types of sensor or computer data that has a log or output, such as system logs, firewall logs, door access logs etc.

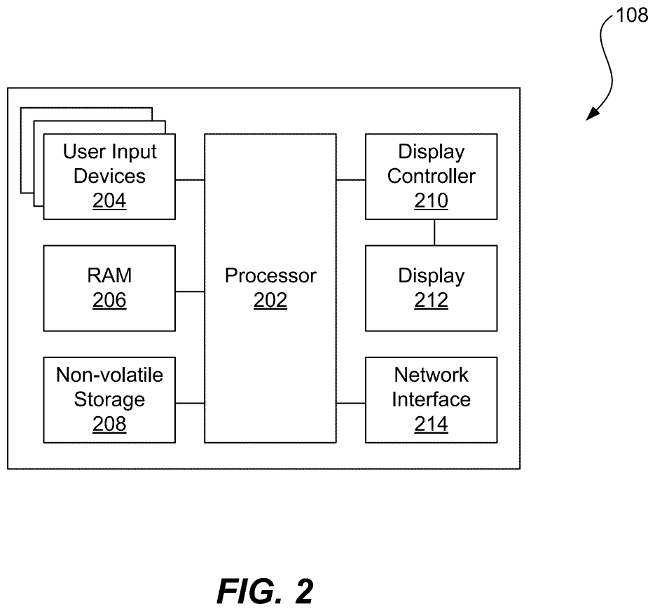

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for detecting insider threat incidents, such as is described in more detail herein below. Additionally or alternatively, the servers 108 may collectively perform that method using distributed computing. While the system depicted in FIG. 2 is described specifically in respect of one of the servers 108, analogous versions of the system may also be used for the user devices 104.

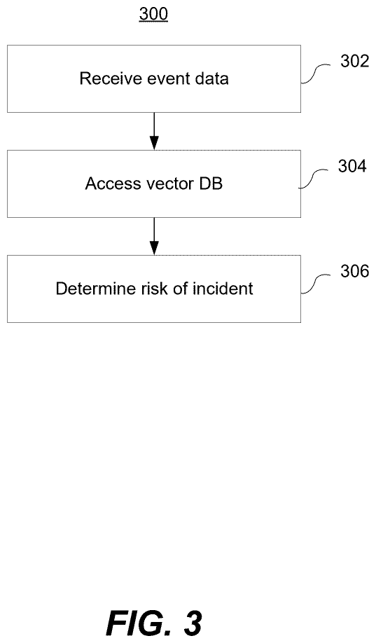

FIG. 3 shows a method 300 of detecting insider threat incidents. The method 300 may be implemented at the one or more servers 108 of the data center 106 of an organization, for example. Instructions may be stored as computer program code, or non-transitory computer-readable instructions, which, when executed by the processor of the server, configures the server to implement the method 300 to perform automatic detection of insider threat incidents.

The method 300 comprises receiving event data of an event to be analyzed for an insider threat (302). The event data may be received from a computing device, such as a user device 104 or a computing device associated with a sensor. The event data may for example originate from a user device 104 based on user (e.g. employee) interactions with a user device. For example, the event data may be an email, a group of emails from a particular employee, etc. The event data comprises content and any associated metadata.

A vector database storing vector representations of known insider threat incidents is accessed (304). A vector database is a specific kind of database that saves information in the form of multi-dimensional vectors representing certain characteristics or qualities. The number of dimensions in each vector can vary widely, from just a few to several thousand, based on the data's intricacy and detail. The vector database in accordance with the present disclosure stores known incident data (e.g. the full email, attachments, and any metadata) in the form of vectors, which may be generated using processes such as machine learning models, word embeddings, or feature extraction techniques. The vector database in accordance with the present disclosure may be generated or otherwise obtained/accessed as part of the method. Preferably, known insider threat incidents are continuously collected and stored in the vector database in near-real-time for subsequent use in analyzing the event data.

A risk that the event is an insider threat incident is determined based on the event data and the vector representations of the known insider threat incidents (306). As described in more detail below, different techniques may be used to determine a risk that the event is an insider threat incident based on the event data and the vector representations stored in the vector database, including but not limited to determining a distance between a vector representation of the event data and the vector representations of the known insider threat incidents, and/or using a contextually-trained large language model to detect insider threat incidents. Further, the contextually-trained large language model may be adaptively managed using updated vector representations stored in the vector database to fine-tune the large language model and to implement Retrieval-Augmented Generation (RAG) by the LLM. As the vector database stores known insider threat incident data that is preferably collected and stored in near-real-time, the determination of risk posed by the event data can be analyzed in consideration of the latest Tactics, Techniques, and Procedures used by threat actors, thus improving accuracy and efficiency of detection.

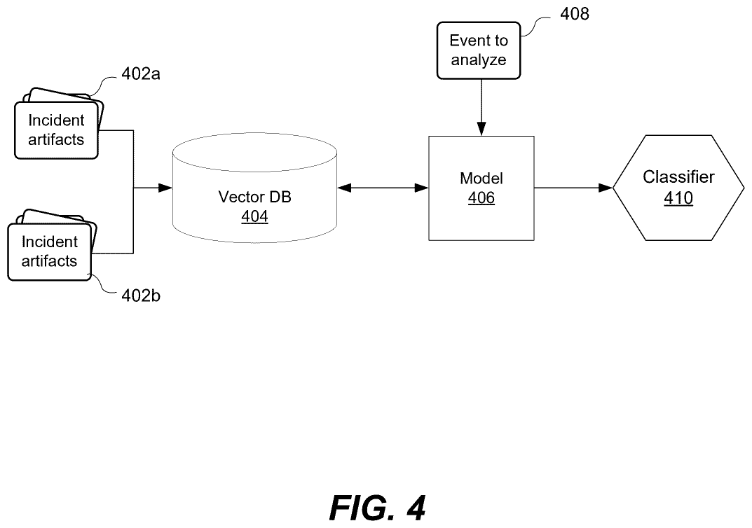

FIG. 4 depicts an architecture of a system for detecting insider threat incidents.

A pipeline is used to pull known insider threat incident artifacts, e.g. incident artifacts 402a and 402b, which are continuously collected (preferably in near-real-time). In the case of emails corresponding to known data loss incidents, for example, the incident artifacts may comprise email content such as body text, attachments, etc., as well as associated metadata such as sender, recipient, date, time, attachment name, size, formats of files, number of recipients, recipient domains, frequency of emails between a sender/recipient pair, etc. The known incident artifacts may be stored in a historical incident database (e.g. a Mongo DB).

A vector database 404 is created that stores vector representations of the known insider threat incident artifacts from the historical incident database. As for example described with reference to the method 300, the vector representations may be generated using machine learning models, word embeddings, or feature extraction techniques. An example of incident data with a message subject stored as vector embeddings using the postgres extension of pgvector is shown in Table 1 below.

TABLE 1

| | incidentid | | |
|---|---|---|---|
| | [PK] | messagedate | messagesubject |
| | integer | date | vector |
| 1 | 11682274 | 2023 May 2 | [−0.795708, −0.6460887, −0.5894474, 0.18406217, 0.0076119183, |
| | | | 0.426174, 0.06527181, 1.1324961, −0.35772282, 0.064701885, 0.91399306, |
| | | | 0.82827055, −0.87523603, −1.078832 . . . |
| 2 | 11698050 | 2023 May 4 | [0.1882308, −0.6248748, −0.35754833, 0.40538284, −0.13112387, |
| | | | 0.8897573, −0.11206228, 0.22225104, 0.5689444, |
| | | | 0.47241816, −0.838175, −1.1286362 . . . |
| 3 | 11944548 | 2023 Jun. 18 | [−0.49694815, −0.45141244, 0.021260237, −0.39113924, 0.093705356, |
| | | | 0.99736863, −0.11996007, −0.100538805, −0.5068238, −0.59260523, |
| | | | 0.2846509, 0.023101306, −0.73936456 . . . |
| 4 | 11945760 | 2023 Jun. 19 | [−0.75041884, −0.50260925, 0.17228213, 0.43424776, 0.4404042, |
| | | | 0.3435123, −0.032982662, 1.0083578, 0.13434583, −0.05478988, |
| | | | 0.27805892, 0.8332935, −0.56335235, −0.4809 . . . |
| 5 | 12051637 | 2023 Jul. 10 | [−0.8425404, −0.09820245, −0.44299474, 1.1703327, |
| | | | 0.09665418, −0.47688422, 0.19522458, 1.2707059, 0.53314936, −0.08569899, |
| | | | 0.6793022, 0.29513332, −09122791, −0.8966063 . . . |
| 6 | 12052763 | 2023 Jul. 10 | [−0.5055953, −0.42388445, −0.25361937, 0.5019386, 0.10261436, |
| | | | 0.6135659, 0.11657524, 0.23412828, 0.15929611, −0.14552504, |
| | | | 0.5785865, −0.85761577, −0.87055 . . . |
| 7 | 12139882 | 2023 Jul. 26 | [−1.5017217, 1.1925826, −0.6732811, 0.7980741, 1.8710048, −0.69980294, |
| | | | 2.2189, 0.34942302, 0.87049586, −1.0078038, 0.9329296, −0.78539556, |
| | | | 0.07700284, −0.8114071, −0.283 . . . |
| 8 | 12286133 | 2023 Aug. 21 | [−09753671, −0.42539844, −0.70868355, |
| | | | 0.8980732, −0.42053527, −0.05918798, 0.1437488, 1.1703137, −0.30476886, |
| | | | 0.30666238, 1.1577427, 0.7174488, −0.20543867, −0.2589076 . . . |
| 9 | 12286342 | 2023 Aug. 21 | [0.2958595, −0.15895751, −0.63818693, 0.061172098, 0.25810903, |
| | | | 1.1793504, 0.435417, 0.3055943, −0.10340226, 0.0479822, 0.2895872, |
| | | | 0.2561252, −098977387, −087399685 . . . |
| 10 | 12351635 | 2023 Sep. 2 | [0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, |
| | | | 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, |
| | | | 0, 0] |
| 11 | 12687261 | 2023 Oct. 12 | [0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, |
| | | | 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, 0, |
| | | | 0, 0] |
| 12 | 12729442 | 2023 Oct. 16 | [−0.08623254, 0.0017272149, −0.08806597, 0.1124227, 0.13156433, |
| | | | 0.44605687, 0.23178282, 0.16410331, 0.045356177, −0.19135103, |
| | | | 0.45542333, 0.0918693, −0.6031198, −0.621 . . . |
| 13 | 12765579 | 2023 Oct. 18 | [−0.50416064, −0.33794096, −0.66326386, −0.29663992, 0.22533713, |
| | | | 0.18208897, −0.1877313, 0.28569385, −0.19158876, −0.26492384, |
| | | | 0.272467, 0.33612064, −0.9792126, 0.0265 . . . |
| 14 | 12911609 | 2023 Oct. 29 | [−0.06319184, −0.58244133, −0.11141313, 0.3825918, 0.53007734, |
| | | | 0.9834538, −0.084446624, 1.1619627, 0.10713086, −0.44403568, 0.19320232, |
| | | | 0.12369276, −057486653, −0.1488 . . . |
| 15 | 12948901 | 2023 Nov. 1 | [−0.32411516, −0.6164992, −0.030073116, 0.39883155, 0.54579973, −0.3419586, |
| | | | 0.58028936, 0.39575687, 0.90263605, −0.16176638, −0.07714482, |
| | | | 0.57196796, −0.37997913, −1.06 . . . |
| 16 | 12953333 | 2023 Nov. 1 | [−1.1841424, −0.7832508, 0.25751397, −0.65777975, −0.489403, −0.22193658, |
| | | | 0.7257696, 0.10970064, −0.39606532, 0.8511358, −0.36956874, −0.044036668, |
| | | | 0.06947156, −0.185317 . . . |
| 17 | 12969132 | 2023 Nov. 3 | [−0.7690017, −08784467, 0.17207822, −0.022429466, −0.22224621, −0.102601334, |
| | | | 0.12346293, 1.4264914, 0.036550403, 0.3174457, 0.847533, |
| | | | 0.7709457, −0.14006272, −0.127930 . . . |
| 18 | 13198392 | 2023 Dec. 7 | [−0.9696528, −0.102028996, −0.54305446, 1.0858393, |
| | | | 0.4109777, −0.6415583, 0.19598094, 0.3652937, −0.1252639, |
| | | | 0.48855546, −0.88858896, −0.09293984, −0.7727 . . . |

A model 406 receives an event 408 to be analyzed. The event to be analyzed may for example be an email, and the event data may be email content and email metadata. The model 406 is configured to determine a risk that the event is an insider threat incident by leveraging the near-real-time known incidents stored in the vector database 404. The model 406 may for example be a comparison tool that compares the event data with the vector representations of the known insider threat incidents stored in the vector database 404. Additionally or alternatively, the model 406 may for example be a contextually-trained large language model. The determination of risk that the event is an insider threat incident may for example be a quantity (e.g. a risk probability based on a distance between vectors) or a determination result (e.g. an output from the LLM).

A classifier 410 is used to generate an output indicative of a detection result (e.g. suspicious/not suspicious; incident/non-incident; etc.) based on the risk determined from the model 406. The classifier 410 may be a machine learning model that assesses the determined risk along with any additional data (e.g. predictions from secondary models) and makes a classification as to whether or not the event data is an insider threat incident. This acts a quorum mechanism whereby if multiple models agree that the event data is a likely incident then probability is higher than if one model agrees and one model disagrees. The classifier 410 can also flag items that disagree for a user to review and understand how to improve the model(s). The classification by the classifier 410 can be output as the detection result.

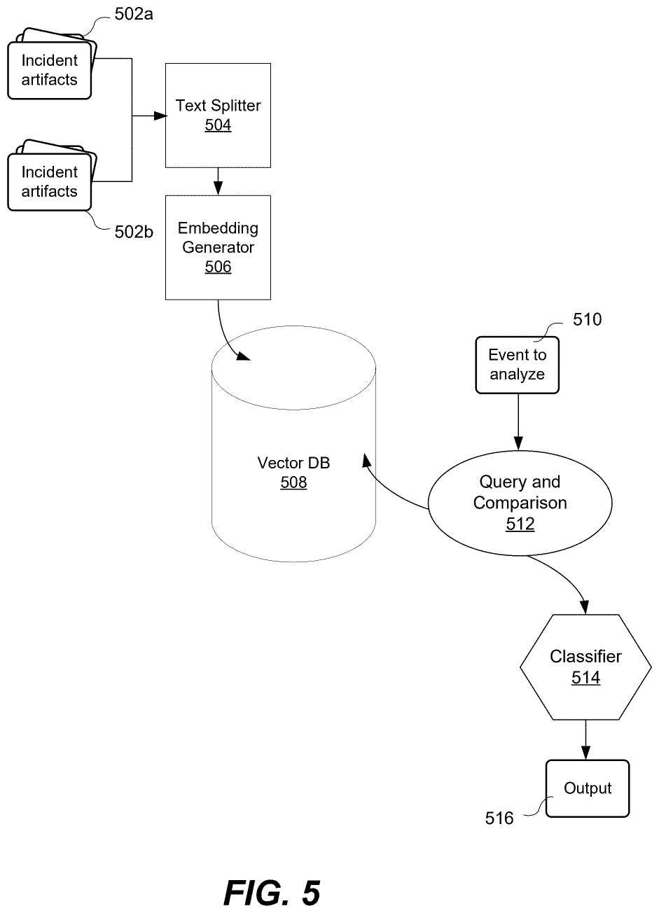

FIG. 5 depicts an exemplary flow diagram for detecting insider threats. The flow shown in FIG. 5 does not use an LLM, but rather performs comparison/classification based on a vector distance between the event data and the known incident data stored in a vector database to make a prediction about the risk of an insider threat incident.

Known insider threat incident artifacts, e.g. incident artifacts 502a and 502b, are transformed into vector representations via a text splitter 504 and embedding generator 506, and stored in a vector database 508.

An event 510 to be analyzed is received at a query and comparison module 512. The query and comparison module compares event data of the event 510 with the known historical insider threat incidents stored in the vector database 508 to determine a risk that the event is an insider threat incident. In an example, the query and comparison module 512 may generate a vector representation of the event data and compare the vector representation of the event data to the vector representations of the known historical insider threat incidents stored in the vector database 508. By using a vector database, similar known historical insider threat incidents can be swiftly and precisely located based on semantic or contextual relevance rather than relying solely on exact matches or set criteria as with conventional databases. The query and comparison module 512 may utilize PGVector to calculate a Euclidean distance to find the similarity between vector embeddings and return the closest predictions. PGVector performs exact nearest neighbor search using Euclidean distance. For example, let V_{d}=x_{1d}, x_{2d}, x_{3d}, . . . , x_{md} be the vector embedding for the incident data and Vₑ=x₁ₑ, x₂ₑ, x₃ₑ, . . . , xₘₑ be the vector embedding for the event data, for Euclidean distance function D_{Ec} the Euclidean distance between these two set of vectors is obtained using Equation (1) as follows.

$${D}_{d e} = \sqrt{{\sum }_{i = 1}^{m} {( {x}_{i e} - {x}_{i d} )}^{2}} \qquad Equation ( 1 )$$

where i=1, 2, . . . , m are the vector dimensions.

As an example, for a sample query of an email subject-line: “FW: Quarterly Reviews Q2” and a similarity (i.e. distance) threshold of less than or equal to 3.5, the following output of the closest known historical incidents may be generated as shown in Table 2 below.

TABLE 2

Incident ID: 12052763
Message Subject: FW: Quarterly Reviews Q2
Distance: 0.0
Incident ID: 11682274
Message Subject: FW: AI Survey
Distance: 3.01612541513718
Incident ID: 12729442
Message Subject: FW: Training Recordings
Distance: 3.1312236609655075

A risk that the event is an insider threat incident may be determined based on the Euclidean distance (e.g. the smaller the distance, the higher the risk, and vice versa). For example, the Euclidean distance will range from 0 to Max, with Max being further away, and a threshold may be defined based on a Monte-Carlo distribution. A composite risk index (e.g. for a particular employee) may also be calculated, based on all or a subset of events (e.g. multiple outbound emails, multiple attachments, etc.) associated with that employee, using Equation (2) as follows.

$$RI = {\sum }_{k = 1}^{n} {r}_{k} = {r}_{1} + {r}_{2} + … + {r}_{n} \qquad Equation ( 2 )$$

where RI denotes the composite risk and n is the total number of risk indicators, r.

The output from the query and comparison module 512 is passed to a classifier 514, which generates an output 516 indicative of a detection result based on the risk determined by the query and comparison module 512. As one example, the classifier may classify events as “Risky”, “Analyze”, or “Non-Risky” based on a threshold value T. For example, the risk r for a given event may be compared directly to the threshold value T for classification. As a further example, let r be the risk value obtained for each event m for an employee with total of M events, a complete risk R for a specific event may be obtained as:

$$∀ m ∈ M , R = {\sum }_{f = 1}^{M} {R}^{f} = \{ \begin{matrix}\begin{matrix}Risky , \\ Analyze , \\ Non risky ,\end{matrix} & \begin{matrix}if r \geq T \\ if r < T \\ if r = 0\end{matrix}\end{matrix}$$

The classification by the classifier (i.e. “Risky”, “Analyze”, or “Non-Risky”) corresponding to a detection result can be output.

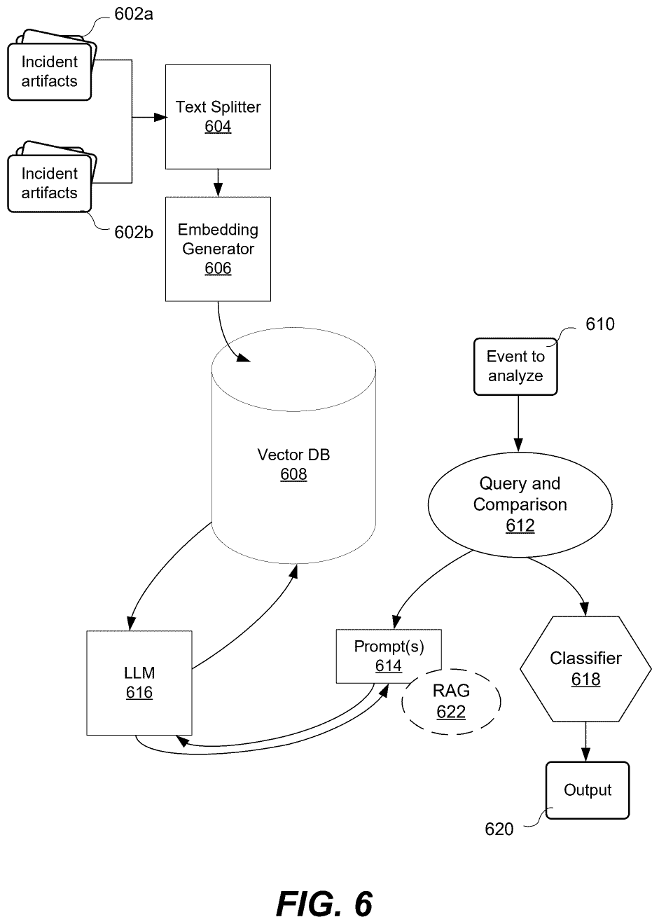

FIG. 6 depicts an exemplary flow diagram for detecting insider threats using a large language model. As described above, the use of LLMs to detect insider threat incidents may be particularly advantageous as they not only provide a determination of a risk that an event is an insider threat incident, but also a reasoning or justification for the determination. The LLM may be an external/pre-trained model, however as these are trained on public data lacking specific context to the organization, these are less accurate and sophisticated prompt engineering is required which needs domain level expertise and also can lead to inconsistent results when models are retrained. Therefore, it is preferable that the LLM used in accordance with the present disclosure is contextually-trained, preferably with known insider threat incident data that is particular to the organization or a field that the organization operates in. The LLM may be contextually trained using a subset of the vector representations stored in the vector database (recognizing that the vector database is being constantly updated with the latest known insider threat incidents). Accordingly, a LLM that is contextually-trained to detect insider threat incidents does not require sophisticated prompt engineering and can more accurately explain its decisions given the vast number of specific examples provided.

As shown in FIG. 6, known insider threat incident artifacts, e.g. incident artifacts 602a and 602b, are transformed into vector representations via a text splitter 604 and embedding generator 606, and stored in a vector database 608. The techniques implemented by the text splitter 604 and embedding generator 606 may be LLM model dependent. Using a tokenizer associated with a specific model in use, the text splitter 604 would break up the text into chunks, then the embedding generator 606 would process the chunks of text into embeddings with a define delimiter. The process may be implemented via Python script as part of the embeddings generation process to make the data compatible for the LLM to process.

An event 610 to be analyzed is received at a query and comparison module 612. The query and comparison module 612 may be similar to the query and comparison module 512 and may use a Euclidian distance operation to identify similar examples of known incident events that resemble the event 610 to be analyzed, which can be fed to the contextually-trained LLM 616 for use in analyzing the event 610. One or more prompt(s) 614 are provided to the contextually-trained LLM 616 to analyze the event 610. The contextually-trained LLM 616 analyzes the event 610 based on the prompt(s) 614 and further based on the similar events of known incidents to determine a risk that the event is an insider threat incident. The output from the LLM 616 can be a determination of whether an event is similar to the known incidents along with an explanation. An example of a prompt for analyzing an email is provided below.

### Sample System Prompt, Instructions and Classification Description

System Prompt: Review the email sent by an employee to an external recipients to detect potential data breaches within the organization, and analyze the email body, subject and attachments for any signs of leakage of sensitive or confidential information that could pose a risk to the organization's reputation, compliance, or security. The analysis should involve examining keywords and content in the given email and attachment data. The employee is permitted to send their own employment-related, non-confidential, and publicly available documents. However, they are prohibited from sharing documents or information pertaining to other employees or clients, confidential or proprietary data, sensitive information, specific project details, work-related documents, presentations, meeting notes, financial documents, internal information, or any data that could harm the organization. Consider the potential advantage the sender may obtain from sending the data outside the organization, which could harm the organization in the future. Also, use the following description in decision making and output the Suspicious or Not-Suspicious labels.

Sender: This means that the email is sent by a specific person or organization that has access to the organization's network or system. It may contain information that is related to the sender's identity, role, function, or affiliation, but also poses a risk of impersonation, spoofing, or phishing if leaked.

Recipient: This means that the email is received by a specific person or organization external to the organization, that belongs to competitor organization OR have a personal domain. It may contain information that is related to the recipient's identity, role, function, or affiliation, but also poses a risk of unauthorized access, disclosure, or misuse if leaked.

Suspicious: This means that the model has identified a potential leakage in the email or attachment based on its analysis and criteria. It may contain information that is related to the organization's employee/client identity, role, function, or affiliation, but also poses a risk of impersonation, spoofing, or phishing if leaked. It may contain RBC internal processes, confidential or proprietary data, financial documents and sensitive data.

Not Suspicious: This means that the model has identified no risk in the email body or attachment based on its analysis and criteria. It may contain sender's information only and not related to organization client data or organization internal processes, documentation and no harm is caused to the organization if it is leaked or manipulated. It may contain information or documents related to recipient or recipient family only.

### Instructions

IF Sender or Recipient is not an authorized employee, contractor, or affiliate AND (Email contains any of the following sensitive information: financial data, client data, health data, proprietary processes, procedures, standards, policies, source code, client lists, contact lists, PCI-DSS data OR Email is addressed to a free email domain or an external domain not affiliated with the organization)] THEN flag the message.

Additionally, IF Sender and Recipient have the same name or address AND (Attachment name contains any of the following sensitive information: financial data, client data, health data, proprietary processes, procedures, standards, policies, source code, client lists, contact lists, PCI-DSS data)] THEN flag the message.

Provide a classification label (‘Suspicious’ or ‘Not-Suspicious’) along with a clear explanation for the reasoning behind your decision in the given format, based solely on the information provided. Do not say further investigation and do not assume or hallucinate information; base your decision on logical analysis and intuition.

### Output Format

### Classification: [Suspicious/Not-Suspicious]

### Reasoning: [Provide Reasoning Based Solely on the Given Information]

Thus, as described above, the use of a contextually-trained LLM 616 requires less sophisticated prompt engineering, and can provide a reasoning for a classification. The prompt comprises a chain-of-thought prompt asking the LLM to explain the steps taken to reach a conclusion. Retrieved knowledge prompts may also be included by providing the examples from the database being fed into the prompt to improve its ability to detect newer incidents. Continuous learning and automated update of the prompts for LLM with the inclusion of new incidents may also be performed. For example, new examples form the vector database can be fed into the prompt used to inspect new events and identify incidents. A Python script may be used to retrieve the most frequently accessed items in the vector database for a specified timeframe. This in effect supplies new examples to the LLM as part of its prompts to enhance the probability of detecting emerging threats based on the most recent and active incidents in the database. Accordingly, by accessing the vector database to find similar events and to prompt the LLM to analyze the event data, the accuracy of the determination is improved.

The output from the LLM 616 is passed back to query and comparison module as the LLM risk determination and reasoning, and to a classifier 618, which generates an output 620 indicative of a detection result based on the risk determined by the LLM 616. The classifier 618 may be a machine learning model that combines the outputs from the LLM with additional data (e.g. from other models that may also be performing insider threat detection) to either substantiate the decision of the LLM or provide evidence to crosscheck the LLM output with other known values from other models. The output may for example classify the event into one of two categories: (1) Incident; and (2) Non-Incident. If model(s) disagree than the event can be flagged for review.

As seen in FIG. 6, the LLM 616 may be improved using Retrieval-Augmented Generation (RAG) 622. The use of RAG addresses a fundamental challenge and cost in having to frequently retrain models to incorporate newer examples of attacks. Combining the LLM-based control with RAG 622 allows to employ the same vector database 608 to provide the LLM-based control with an up-to-date source of incident data to inference against and close the knowledge gap, without requiring retraining. This allows for a near instant adaptable response to real-world threats as incident data is collected/aggregated and stored in the vector database 608. Accordingly, RAG can be used to preserve the model's core functionalities while incorporating real-time information updates stored in the vector database. Once validated the data in the vector database 608 is available for immediate use by the LLM 616 as part of the RAG approach.

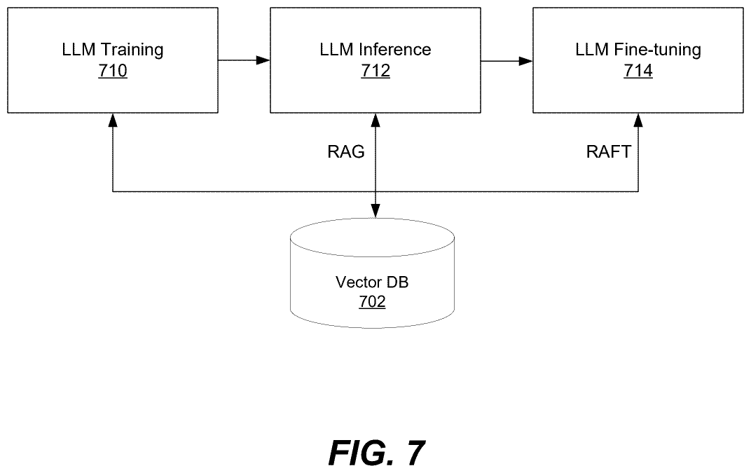

FIG. 7 shows a representation of how the vector database is used by a large language model.

As described herein, a vector database 702 contains a set of existing, recent, and near-real-time examples of real-world cybersecurity/insider threat incidents derived from automated detection and human investigations (thus incorporating Reinforcement Learning Through Human Feedback (RLHF)).

The vector database 702 may be used to train the LLM (710). The LLM may be an external model trained on public or third party data, however it will be appreciated that contextually-training on data in the vector database 702 will improve the inference accuracy. In some examples, the LLM may be trained to analyze outbound emails and determine/classify the emails into categories, such as suspicious/not suspicious, or incident/non-incident. In addition to this output, the LLM can also give reasoning or justification for this belief. The LLM may for example be based on the LLama 2 model and trained with known internal incident data. LLama-2 is comprised of a family of pretrained and fine-tuned LLMs, ranging in scale from 7B to 70B parameters (7B, 13B, 70B). In an example implementation, the LLM in the present disclosure may use the 7B model with context length of 4K.

The contextually-trained LLM may also access the vector database 702 at inference (712) using RAG techniques. Accordingly, the data stored in the vector database 702 is used along with the LLM's built-in weights to generate domain specific answers.

Further, the vector database 702 may be used for model fine-tuning (714) using Retrieval-Augmented Fine-Tuning (RAFT). In some examples, the database maintains a count of the number of times each record has been accessed. This count allows to record the frequency with which examples have matched lookups of similar types of indicators. The system may use this ever growing list of examples and its access frequency to continuously adjust probability of occurrence, prioritize the most frequently accessed examples for fine-tuning the foundation model and improving efficiency. The subsequent use of access frequency to fine-tune the LLM to embed within its weights the most common examples significantly improves its performance and it's domain specific adaptability over time. The addition of a counter that allows for the tracking of access frequency significantly improves the ability to track the occurrences of specific TTPs and to significantly enhance the effectiveness and efficiency of fine-tuning cycles.

Accordingly, it can be appreciated that the integration of RAG and RAFT to preserve the model's core functionalities while incorporating real-time information updates helps to combat AI model challenges such as model drift, overfitting, and unintended biases, and for adaptive AI model management. The strategic application of fine-tuning and RAG ensures the model's adaptation to new information. Fine-tuning with real-incident data enables the model to align with contemporary developments. Active learning strategies allow to intelligently select incident data for fine-tuning, focusing on areas where the model's performance can be most significantly improved. The use of RAG addresses a fundamental challenge and cost in having to frequently retrain models to incorporate newer examples of attacks. The approach disclosed herein allows for significant cost savings and less frequent model fine-tuning, while simultaneously allowing for an existing model to have access to near-real-time examples.

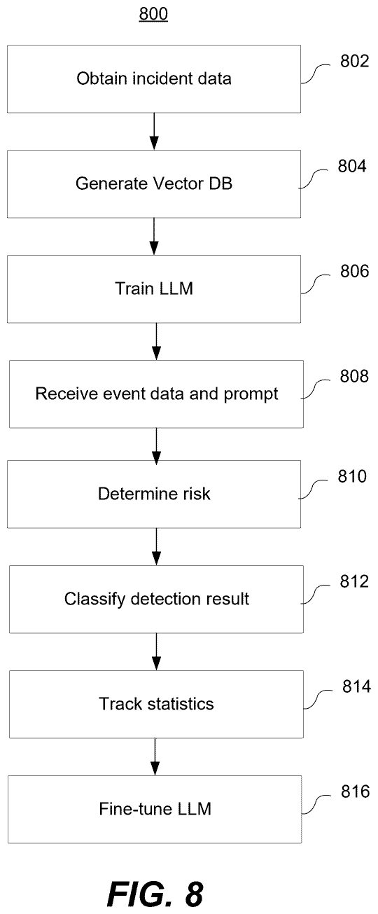

FIG. 8 shows a further method 800 of detecting insider threat incidents. The method 800 involves use of a contextually-trained LLM and combines several of the aspects described above. The method 800 may be implemented at the one or more servers 108 of the data center 106 of an organization, for example. Instructions may be stored as computer program code, or non-transitory computer-readable instructions, which, when executed by the processor of the server, configures the server to implement the method 800 to perform automatic detection of insider threat incidents.

Incident data of known insider threat incidents are obtained (802). The insider threat incidents may pertain to data loss incidents, and may for example comprise email data and any associated metadata.

A vector database is generated (804). The vector database is generated by generating vector representations of the known insider threat incidents and storing the vector representations in the database.

A large language model (LLM) is contextually trained (806) using the known insider threat incidents. In particular, a subset of the vector representations stored in the vector database may be used for training the LLM. As described above, known insider threat incidents are preferably being collected in near-real-time and added to the vector database. Accordingly, the LLM may be trained using a first set of vector representations, after which further vector representations of subsequent known insider threat incidents may be added to the database.

The LLM receives event data to be analyzed and a prompt instructing how to analyze the event data (808). The LLM determines a risk that the event is an insider threat incident based on the vector representations of the known insider threat incidents (810). As described above, the LLM preferably utilizes RAG techniques to determine the risk, thus utilizing additional known incidents that have been added to the vector database beyond what the LLM was trained on. The output of the LLM, which comprises a determination of risk along with context of the determination, is passed to a classifier, which classifies the risk that the event is an insider threat incident and generates an output indicative of a detection result (812).

Preferably, statistics of a number of times each record in the vector database has been accessed are tracked (814). Accordingly, the large language model may be fine-tuned based on the statistics (816). The fine-tuning may comprise performing RAFT techniques.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of detecting insider threat incidents, comprising:
receiving event data from a computing device of an event to be analyzed for an insider threat;
accessing a vector database storing vector representations of known insider threat incidents; and
determining a risk that the event is an insider threat incident based on the event data and the vector representations of the known insider threat incidents.

2. The method of claim 1, further comprising generating the vector database storing the vector representations of known insider threat incidents by obtaining the known insider threat incidents and generating vector representations of the known insider threat incidents.

3. The method of claim 2, wherein the known insider threat incidents are obtained in near-real-time.

4. The method of claim 1, further comprising generating a vector representation of the event data, wherein determining the risk is based on a distance between the vector representation of the event data and the vector representations of the known insider threat incidents.

5. The method of claim 1, wherein the risk is determined using a large language model that has been contextually-trained on known insider threat incidents.

6. The method of claim 5, wherein the large language model performs retrieval-augmented generation using the vector database to determine the risk.

7. The method of claim 5, further comprising maintaining statistics of a number of times each record in the vector database has been accessed, and fine-tuning the large language model based on the statistics.

8. The method of claim 5, further comprising training the large language model based on a subset of the vector representations stored in the vector database.

9. The method of claim 1, further comprising classifying the risk that the event is an insider threat incident and generating an output indicative of a classification result.

10. The method of claim 1, wherein the insider threat incident pertains to data loss.

11. The method of claim 1, wherein the event data comprises email data.

12. A system for detecting insider threat incidents, comprising:
a vector database storing vector representations of known insider threat incidents;
a processor; and
a non-transitory computer-readable medium having computer-executable instructions stored thereon which, when executed by the processor, configure the system to perform a method of detecting insider threat incidents, comprising:
receiving event data from a computing device of an event to be analyzed for an insider threat;
accessing the vector database based on the event data; and
determining a risk that the event is an insider threat incident based on the event data and the vector representations of the known insider threat incidents.

13. The system of claim 12, wherein the instructions when executed by the processor further configure the system to generate the vector database storing the vector representations of known insider threat incidents by obtaining the known insider threat incidents and generating vector representations of the known insider threat incidents.

14. The system of claim 12, wherein the instructions when executed by the processor further configure the system to generate a vector representation of the event data, wherein determining the risk is based on a distance between the vector representation of the event data and the vector representations of the known insider threat incidents.

15. The system of claim 12, wherein the risk is determined using a large language model that has been contextually-trained on known insider threat incidents.

16. The system of claim 15, wherein the large language model performs retrieval-augmented generation using the vector database to determine the risk.

17. The system of claim 15, wherein the instructions when executed by the processor further configure the system to maintain statistics of a number of times each record in the vector database has been accessed, and fine-tune the large language model based on the statistics.

18. The system of claim 15, wherein the instructions when executed by the processor further configure the system to train the large language model based on a subset of the vector representations stored in the vector database.

19. The system of claim 12, wherein the instructions when executed by the processor further configure the system to classify the risk that the event is an insider threat incident and generate an output indicative of a classification result.

20. A non-transitory computer-readable medium having computer-executable instructions stored thereon which, when executed by a processor, configure the processor to perform a method of detecting insider threat incidents, comprising:
receiving event data from a computing device of an event to be analyzed for an insider threat;
accessing a vector database storing vector representations of known insider threat incidents; and
determining a risk that the event is an insider threat incident based on the event data and the vector representations of the known insider threat incidents.
